(19) United States
(12) Patent Application Publication
(10) Pub. No.: US 2009/0082703 A1
(43) Pub. Date: Mar. 26, 2009

(54) Method and apparatus for the treatment of tendon abnormalities

(76) Inventor: Robert Muratore, Huntington, NY (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 11/904,195

(22) Filed: Sep. 26, 2007

(51) Int. Cl. A61H 1/00

(52) U.S. Cl. 601/2

(57) ABSTRACT

The present disclosure relates to a method of treating abnormalities in a tendon through the use of high intensity therapeutic ultrasound (HITU) energy.

### BACKGROUND

1. Technical Field

The present invention relates generally to the treatment of abnormalities in a anatomical tissue with high intensity therapeutic ultrasound (HITU) energy and, more particularly, to the treatment of tendon abnormalities.

2. Background of Related Art

Tendons are comprised of elastic tissue connecting muscle to bones. Joint movements are facilitated by transmission of the forces produced by muscles through the tendons to the bones, thereby repeatedly subjecting tendons to enormous stresses. The elasticity of the tendons is sometimes insufficient to accommodate the strains and thus, tendons often suffer small tears. In addition, when a tendon is overused, strained, or injured, some of the tendon tissue is replaced with thick, dense scar tissue that is substantially less elastic than the normally elastic tendon tissue. When such scarring occurs, as the muscle that is attached to the tendon contracts, the normal tissue pulls on the dense, non-elastic scar tissue, which then pulls against the bone, often causing discomfort or pain.

Histopathologically, tendon injuries and abnormalities are generally classified as “tendinopathies”, which may be sub-classified into peritenonitis, tendinitis, tendinosis or peritenonitis with tendinosis. Peritenonitis is the first stage of tendonitis and is characterized by localized burning or pain during or following activity. Ultimately, peritenonitis may result in the rupture or tearing of a tendon. Tendinosis is characterized by an asymptomatic, non-inflammatory, degenerative disease process in which thickened and yellowish areas of mucoid degeneration are present within the tendon itself, causing the tendon to lose its normal coloration and striation patterns. Peritenonitis with tendinosis is characterized by nodularity and activity related pain and diffuse swelling of the tendon sheath, and may result in one or more of the symptoms related to either peritenonitis or tendinosis.

The application of HITU to tissue, e.g. a tendon, may yield significant physiological effects including either or both of thermal or mechanical changes. Thermal changes include an increase in tissue temperature to a level significant enough to effectuate physical changes including the creation of lesions, tissue ablation, coagulation, denaturation, destruction or necrosis. To produce such effects, HITU devices, are positioned in relation to target tissue and are caused to discharge ultrasound energy thereupon, either through direct contact with the tissue or through the employ of a coupling member.

Currently, there are several techniques available for the treatment of tendon abnormalities including localized injections, percutaneous tenotomy and extracorporeal shock wave therapy (ESWT). Localized injections comprise the percutaneous insertion of a needle and into target tissue such that steroids and/or anesthetics may be administered. Percutaneous tenotomy comprises inserting either a needle or a blade, generally, through a patient's skin to deliberately fenestrate tissue to induce bleeding and/or to break-up calcifications. While somewhat effective, both localized injections and percutaneous tenotomy are invasive procedures in that they require the penetration of a patient's skin. ESWT involves the focusing of high-intensity ultrasonic acoustic radiation upon the target area. While generally less invasive, in that ESWT does not require the penetration or incising of the patient's skin, the focal region of the radiation is relatively broad and difficult to aim, potentially resulting in damage to the bone and/or tissue surrounding the target area.

Given these deficiencies, there exists a need for a minimally invasive procedure that is efficacious in the treatment of tendon abnormalities.

### SUMMARY

The present disclosure relates to a method of treating tendon abnormalities which includes providing a HITU device, positioning the HITU device relative to the tendon such that the HITU device defines a focal point on the tendon, and discharging a HITU beam to treat the abnormality. In one embodiment, the focal point is defined by a HITU device that includes a focused array. Arrays can be made from piezoelectric ceramic, may be flat or curved and may be focused by means of either phasing or the structural curvature thereof. In an alternate embodiment, the HITU device includes a single element which may also be manufactured from a piezoelectric ceramic, or any other suitable material.

In positioning the HITU device above the tendon, the HITU device may be positioned such that a focal distance is defined between the focal point and a surface of the HITU device that is equal to the radius of curvature of the focused array. This focal distance may be substantially within the range of about 25 mm to about 35 mm. In addition, the device may be positioned such that a focal depth is defined between the focal point and tissue overlying the tendon, that is substantially within the range of about 1 mm to about 8 mm. In repositioning the HITU device, the focal depth may be varied. The HITU device may be positioned such that the HITU beam forms an angle of incidence with tissue overlying the tendon that is substantially within the range of about 0° to about 90°.

In the step of discharging the HITU beam from the HITU device, a HITU beam having a strength substantially within the range of about 1 watt to about 100 watts and a frequency substantially within the range of about 200 kHz to about 15 MHz is focused on the tendon for an insonification period that is substantially within the range of about 1 second to about several minutes.

In discharging the HITU beam, a therapeutic effect is created that may include the selective creation of at least one lesion with respect to at least one target site associated with the tendon, and the encouragement of blood vessels into an area of the tendon associated with the abnormality, thereby at least partially dissolving scar tissue, stimulating the formation of fibrous tissue, and/or the erosion of one or more calcifications.

### BRIEF DESCRIPTION OF THE DRAWINGS

The accompanying drawings, which are incorporated in, and constitute a part of this specification, illustrate embodiments of the disclosure and, together with a general description of the disclosure given above and the detailed description of the embodiment(s) given below, serve to explain the principles of the disclosure, wherein:

FIG. 1 is a side view of a system used in the treatment of tendon abnormalities, in accordance with the principles of the present disclosure; and

FIG. 2 is a side view of one embodiment of the HITU device of FIG. 1.

### DESCRIPTION OF VARIOUS EMBODIMENTS

Various embodiments of the presently disclosed method will now be described in detail with reference to the foregoing figures wherein like reference numerals identify similar or identical elements.

In the figures, and in the description which follows, the term high intensity therapeutic ultrasound, or HITU, should be understood as collectively referring to both thermal HITU and inertial cavitational HITU, or histotripsy, as well as to the techniques of high intensity focused ultrasound (HIFU) and focused ultrasound surgery (FUS). In addition, the term HITU should be understood as including the techniques of high intensity focused ultrasound (HIFU) and focused ultrasound surgery (FUS). Moreover, throughout the present disclosure, when used in reference to tissue or to a tendon, the term “abnormality” shall be interpreted as including scarring, tendinosis, peritenonitis, any combination thereof, or any other malformation, irregularity, or abnormality either on the surface of a tendon or therebeneath.

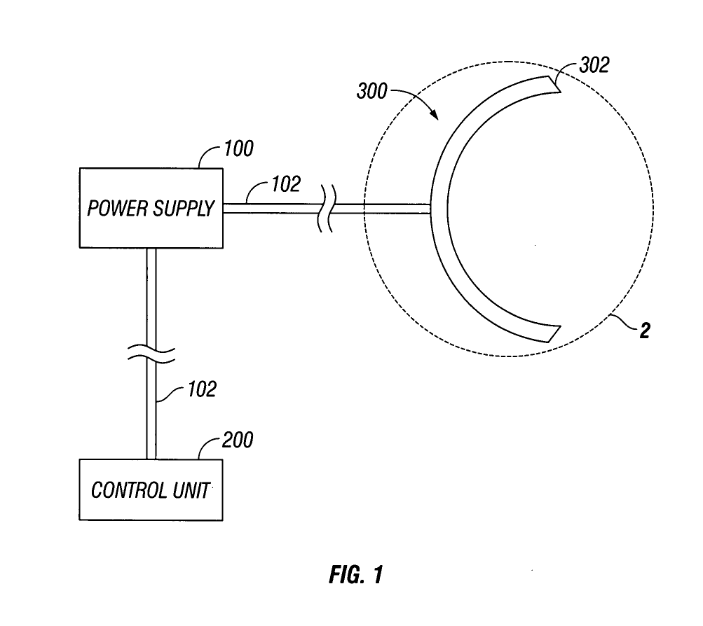

Referring now to the drawings, FIG. 1 illustrates a HITU assembly system 10 for use in the treatment of tendon abnormalities in accordance with the principles of the present disclosure. System 10 includes a power supply 100, a control unit or module 200, and a HITU device 300.

Power supply 100 is connected to both control unit 200 and HITU device 300 such that power, e.g. an electrical or RF current, may be supplied thereto. Power supply 100 may be connected to control unit 200 and HITU device 300 in any suitable manner, including but not being limited to the use of an electrical cord 102 or one or more transmission wires (not shown). Electrical current provided by power supply 100 is discharged into HITU device 300, thereby producing vibration of one or more piezoelectric elements (not shown), as discussed below, thereby producing acoustic or ultrasonic waves or energy.

Control unit 200 regulates the supply of power from power supply 100 to HITU device 300 such that HITU device 300 may generate a HITU beam that may vary in intensity or volume during an insonification period. The present disclosure contemplates that the HITU beam generated by HITU device 300 may be substantially within the range of about 1 watts to about 100 watts, although a beam of significantly lesser or greater intensity is also contemplated herein. In addition, the present disclosure contemplates an insonification period substantially within the range of about one second to about several minutes. However, dependent upon the particular application or procedure in which HITU device 300 may be employed, substantially greater and lesser periods of insonification are contemplated.

Control unit 200 may include a control panel (not shown) and display monitor (not shown), one or more switches (not shown) for current control, an input mechanism (not shown), such as a keyboard, and/or a microprocessor (not shown) including memory, storage and data processing capabilities for performing various functions. The control unit may be configured to selectively activate one or more switches corresponding to one or more transducer elements x, which are discussed in further detail below, to effect the actuation thereof to generate ultrasound energy.

HITU device 300 includes a transducer 302, and may further include additional elements, such as a handle assembly (not shown), to facilitate the use and operation of the HITU device. In the interests of brevity, such additional elements will not be discussed herein, but their inclusion is not beyond the scope of the present disclosure. Exemplary transducers may be seen in U.S. Pat. Nos. 4,484,569, 6,039,689, and 6,846,290 the contents of which are incorporated by reference herein in their entirety.

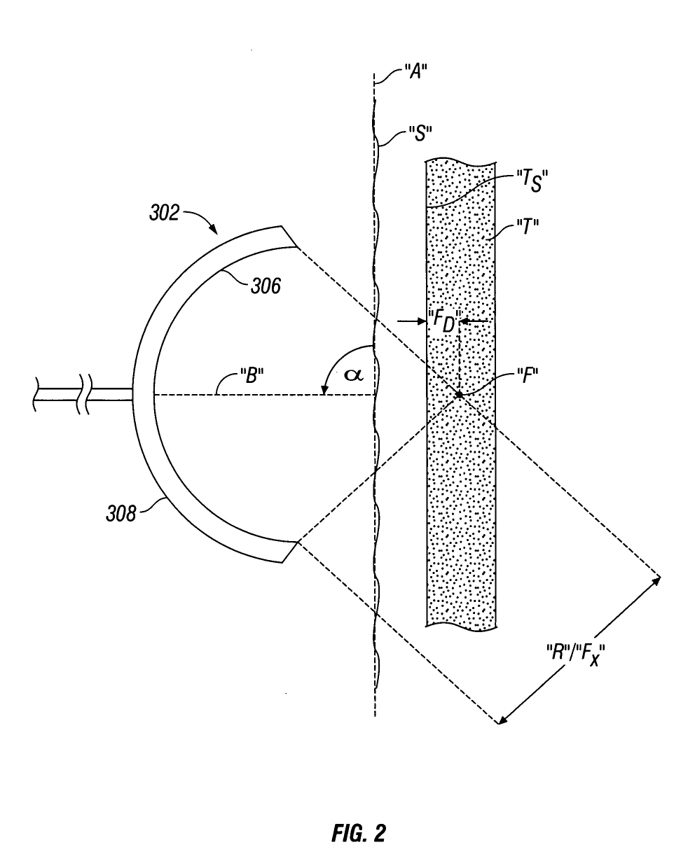

Referring now to FIGS. 1-2, transducer 302 is configured to generate and emit ultrasound energy in the form of a HITU beam upon the delivery of power thereto, e.g. an electrical current, from power supply 100, and may be any structure suitable for that intended purpose. In one embodiment, transducer 302 may include one or more individual ultrasound emitting elements or transducer elements. In an alternate embodiment, transducer 302 may be a piezoelectric element that vibrates or oscillates to produce ultrasound energy upon the delivery of power thereto, and may be formed of any material suitable for the intended purpose of producing or generating ultrasound energy, including but not being limited to ceramic materials. The HITU beam generated by transducer 302 will generally have a frequency between about 200 kHz to about 15 MHz. However, a HITU beam having a frequency that is either substantially greater or lesser is also within the scope of the present disclosure.

Surface 306 of transducer 302 exhibits a configuration, orientation, or geometry that is particularly adapted to focus or converge the ultrasound energy generated thereby at a focal point “F”. In one embodiment, transducer 302 comprises a focused array 308 having a surface 306 with a radius of curvature “R” and a concave configuration. In this embodiment, focal point “F” and surface 306 define a focal distance “F_{X}” therebetween that is equal to the radius of curvature “R” of surface 306 of focused array 308. In particular, the present disclosure contemplates that the radius of curvature “R” of surface 306 of transducer 302 may be substantially within the range of about 25 mm to about 35 mm, although radii of curvature that are substantially greater or lesser are also within the scope of the present disclosure.

During operation, HITU device 300 is positioned such that the HITU beam generated by transducer 302 is focused at focal point “F” on a tendon “T”. By focusing the ultrasound energy in one or more target areas, thermal and physical changes in the tissue can be restricted to a particular, localized region, thereby substantially minimizing any such effects on the tissue surrounding the target area, including a patient's skin. The distance between the tendon surface “T_{S}” and the focal point “F” is known as the focal depth “F_{D}”. The present disclosure contemplates a focal depth “F_{D}” that is substantially within the range of about 1 mm to about 8 mm, although a substantially greater or lesser focal depth “F_{D}” is also within the scope of the present disclosure. Focal depth “F_{D}” may be varied during the course of a procedure by moving HITU device 300 and transducer 302 in relation to the target tendon such that different areas of the tendon may be target and treated. When the focal depth is greater than 0 mm, i.e. when the ultrasound energy is focused at a distance that is removed from the tendon surface “T_{S}”, and therefore, the patient's skin or tissue “S” overlying the tendon “T” as well, the ultrasound energy generated and emitted by transducer 302 will have minimal thermal and physical effects of upon the patient's skin “S”.

During insonification, it will often be difficult to achieve an angle of 90° between the HITU beam generated and emitted by the transducer and the area of the tendon “T” to be treated. Accordingly, the present disclosure contemplates that the HITU beam may be applied to the tendon “T” at an angle of incidence a formed with an axis “B” that is transverse to the axis “A” defined by the tendon “T”. When applied to the tendon “T” at such an angle, refraction of the HITU beam occurs, increasing as the angle of incidence a increases, as well as the length of the path taken by the HITU beam through the tissue of the tendon “T”. The angle of incidence a may be any angle substantially within the range of about 0° to 90°.

Referring still to FIGS. 1-2, a method of treating one or more abnormalities in a tendon will now be disclosed. Initially, a HITU device in accordance with the above disclosure, e.g. HITU device 300, must be positioned relative to a target tendon “T” such that the focal point “F” is coincident with the target area, or the area of the tendon “T” to be treated. Subsequently, transducer 302 of HITU device 300 is energized with power from power supply 100 such that a HITU beam is generated and emitted by transducer 302 upon the target area of the tendon “T” such that the abnormality may be treated.

The HITU beam generated by transducer 302 may be used to create a variety of therapeutic effects. The HITU beam may be used to aggravate the tissue comprising the tendon “T” through the selective creation of one or more lesions, thereby encouraging the flow of blood into the region, promoting the regeneration of any damaged or scarred tissue, the erosion of calcifications, and the growth of new, healthy, fibrous tendon tissue.

While the above is a complete description of the embodiments of the present disclosure, various alternatives, modifications and equivalents may be used. Therefore, the above description should not be construed as limiting, but rather as illustrative of the principles of the disclosure made herein. Those skilled in the art will envision other modifications within the scope and spirit of the claims appended hereto.

What is claimed is:

1. A method of treating an abnormality associated with a tendon, comprising:
providing a HITU device;
positioning the HITU device relative to the tendon, wherein the HITU device defines a focal point on the tendon; and
discharging a HITU beam from the HITU device to treat the abnormality.

2. The method of claim 1, wherein the step of providing a HITU device comprises providing a HITU device that includes a focused array, wherein the focused array defines the focal point.

3. The method of claim 1, wherein the step of providing a HITU device comprises providing a HITU device that includes a piezoelectric ceramic element.

4. The method of claim 2, wherein the step of positioning the HITU device relative to the tendon includes positioning the HITU device such that the focal point and a surface of the HITU device define a focal distance therebetween that is equal to the radius of curvature of the focused array.

5. The method of claim 4, wherein the step of positioning the HITU device relative to the tendon includes positioning the HITU device such that the focal distance is substantially within the range of about 25 mm to about 35 mm.

6. The method of claim 1, wherein the step of positioning the HITU device relative to the tendon includes positioning the HITU device such that a focal depth is defined between the focal point and tissue overlying the tendon.

7. The method of claim 6, wherein the step of positioning the HITU device relative to the tendon includes positioning the HITU device such that the focal depth is substantially within the range of about 1 mm to about 8 mm.

8. The method of claim 6, wherein the step of positioning the HITU device relative to the tendon includes repositioning the HITU device such the focal depth may be varied.

9. The method of claim 1, wherein the step of positioning the HITU device relative to the tendon includes positioning the HITU device such that the HITU beam discharged therefrom forms an angle of incidence with tissue overlying the tendon that is substantially within the range of about 0° to about 90°.

10. The method of claim 9, wherein the step of positioning the HITU device relative to the tendon includes positioning the HITU device such that the angle of incidence is substantially within the range of about 5° to about 30°.

11. The method of claim 1, wherein the step of discharging the HITU beam from the HITU device to treat the abnormality includes focusing the HITU beam on the tendon for an insonification period of at least about 1 second.

12. The method of claim 1, wherein the step of discharging the HITU beam from the HITU device to treat the abnormality includes discharging a HITU beam having a strength substantially within the range of about 1 watts to about 100 watts.

13. The method of claim 1, wherein the step of discharging the HITU beam from the HITU device to treat the abnormality includes discharging a HITU beam having a frequency substantially within the range of about 200 kHz to about 15 MHz.

14. The method of claim 1, wherein the step of discharging the HITU beam from the HITU device to treat the abnormality includes discharging the HITU beam such that a therapeutic effect is created.

15. The method of claim 14, wherein the step of discharging the HITU beam from the HITU device to treat the abnormality includes discharging the HITU beam such that at least one lesion is selectively created with respect to at least one target site associated with the tendon.

16. The method of claim 14, wherein the step of discharging the HITU beam from the HITU device to treat the abnormality includes discharging the HITU beam such that blood vessels are encouraged to enter an area of the tendon associated with the abnormality and thereby at least partially dissolve scar tissue.

17. The method of claim 14, wherein the step of discharging the HITU beam from the HITU device to treat the abnormality includes discharging the HITU beam such that the formation of fibrous tissue is stimulated.

18. The method of claim 14, wherein the step of discharging the HITU beam from the HITU device to treat the abnormality includes discharging the HITU beam such that one or more calcifications are eroded.
